(19) United States
(12) Patent Application Publication
(10) Pub. No.: US 2026/0121404 A1
(43) Pub. Date: Apr. 30, 2026

(54) Method and System for Controlling Overvoltage in Photovoltaic Court Based on Floating Neutral Voltage

(71) Applicant: Guizhou Power Grid Co., Ltd., Guiyang (CN)

(72) Inventors: Yu ZHANG, Guiyang (CN); Yan ZHANG, Guiyang (CN); Julong CHEN, Guiyang (CN); Xueyong TANG, Guiyang (CN); Zhaofeng ZHANG, Guiyang (CN); Jierui YANG, Guiyang (CN); Jie WANG, Guiyang (CN); Bin WANG, Guiyang (CN); Leichen YANG, Guiyang (CN); Xin YANG, Guiyang (CN); Yongqing ZHU, Guiyang (CN); Nan MOU, Guiyang (CN); Chuan QIN, Guiyang (CN); Ming LEI, Guiyang (CN); Chao LIN, Guiyang (CN); Qian CHEN, Guiyang (CN)

(21) Appl. No.: 19/009,043

(22) Filed: Jan. 3, 2025

Related U.S. Application Data
(63) Continuation of application No. PCT/CN2024/135912, filed on Nov. 29, 2024.

(30) Foreign Application Priority Data
Dec. 18, 2023 (CN) 2023117343046

(51) Int. Cl. H02J 3/00; H02J 3/38

(52) U.S. Cl. CPC H02J 3/00125; H02J 3/381; H02J 2101/24

(57) ABSTRACT

The present invention discloses a method and a system for controlling an overvoltage in a photovoltaic court based on a floating neutral voltage, including: acquiring, by a controller, a voltage U of the photovoltaic court and a voltage U₀ of a transformer neutral point; comparing acquired voltage data with a set threshold; generating control instructions of offsetting and compensation according to a comparison result; and receiving the instructions by a neutral voltage regulator, and controlling a voltage. The present invention introduces a floating neutral line between a photovoltaic power supply and a grid-connected transformer neutral point, and arranges a neutral voltage regulator on the floating neutral line. By adjusting its direction and size, the neutral voltage regulator can adapt to the voltage problem of the court in different states. Meanwhile, by adjusting the voltage on the grid-connected transformer neutral point side, the voltage of the grid-connected transformer neutral point is zero.

### CROSS-REFERENCE TO RELATED APPLICATIONS

The present application claims priority to Chinese Patent Application No. 2023117343046, filed on Dec. 18, 2023, the entire disclosure of which is incorporated herein by reference.

### TECHNICAL FIELD

The present invention relates to the technical field of voltage control, and in particular to a method and a system for controlling an overvoltage in a photovoltaic court based on a floating neutral voltage.

### BACKGROUND

The “carbon peaking and carbon neutrality” strategy provides a new direction for energy development. By limiting carbon emissions of traditional fossil energy and increasing a proportion of new energy power generation, photovoltaic power generation has been widely used in recent years. Also, photovoltaic energy has become an important driving force to achieve the goal of “carbon peaking and carbon neutrality” due to its wide coverage, convenient installation location and other characteristics. However, in order to further increase a proportion of photovoltaic power generation in a power grid and ensure safety of electricity consumption in a photovoltaic court, it is necessary to deeply research and solve the problems in the photovoltaic field at a current stage.

The main problems include a voltage fluctuation, limited reactive control of a photovoltaic inverter, an insufficient carrying capacity of the power grid at a load valley, etc. In a case of excessive photovoltaic power output, a reverse flow power in the court appears to cause an overvoltage phenomenon in the court; while in a case of insufficient photovoltaic power output at night, a low voltage phenomenon will also appear in the court, so that the voltage fluctuation of a power grid in the photovoltaic court is more significant. However, it is dissatisfied that inductive reactance is much larger than a resistance in a low-voltage distribution network, which makes traditional decoupling control no longer applicable. Reactive control of the photovoltaic inverter is difficult to effectively offset a voltage rise caused by active reverse power transmission due to its limited capacity. In order to maintain stable operation of the power grid and reduce the voltage fluctuation, a current method is mainly to adjust an output power of a photovoltaic power generation system by active control. However, because active control may affect the economic benefits of photovoltaic power generation, it has become a constraint.

In addition, as a grounding lead of a distribution transformer may make a poor contact to a grounding body due to severe soil corrosion, a grounding resistance of a transformer neutral point is large. In this way, in a case of a ground fault of a certain phase of the low voltage to the ground on a photovoltaic court side, a potential of the neutral point to the ground will rise, which in turn leads to neutral line electrification. It endangers safety of residents' electricity consumption and staff maintenance, and may even cause serious accidents such as a fire and an electric shock.

Aiming to these problems, the present invention provides a method for controlling an overvoltage in a photovoltaic court based on a floating neutral voltage. This method introduces a floating neutral line between a photovoltaic power supply and a grid-connected transformer neutral point, and arranges a neutral voltage regulator on the floating neutral line. By adjusting its direction and size, the neutral voltage regulator can adapt to the voltage problem of the court in different states. Meanwhile, by adjusting the voltage on the grid-connected transformer neutral point side, the voltage of the grid-connected transformer neutral point is zero.

### SUMMARY

In view of the existing problems mentioned above, the present invention is provided.

Therefore, the technical problems solved by the present invention are large power consumption, a high cost and other problems of an existing overvoltage control method.

To solve the above technical problems, the present invention provides the following technical solution: a method for controlling an overvoltage in a photovoltaic court based on a floating neutral voltage includes:

Acquiring, by a controller, a voltage U of the photovoltaic court and a voltage U₀ of a transformer neutral point;
comparing acquired voltage data with a set threshold;
generating control instructions of offsetting and compensation according to a comparison result; and
receiving the instructions by a neutral voltage regulator, and controlling a voltage.

As a preferred solution of the method for controlling the overvoltage in the photovoltaic court based on the floating neutral voltage of the present invention, an overvoltage control apparatus includes: a floating neutral line, having one end connected to a photovoltaic power supply and the other end connected to a grid-connected transformer neutral point;
the neutral voltage regulator, connected to the grid-connected transformer neutral point of the floating neutral line; and
a controller, connected to the neutral voltage regulator and capable of acquiring a voltage of the photovoltaic court and a voltage of the transformer neutral point, calculating a direction and a magnitude of an output voltage of the neutral voltage regulator, and sending the direction and the magnitude to the neutral voltage regulator.

As a preferred solution of the method for controlling the overvoltage in the photovoltaic court based on the floating neutral voltage of the present invention, the overvoltage control apparatus further includes: the floating neutral line can form a closed loop between the transformer neutral points on both sides of the neutral line and the photovoltaic power supply, so that the voltage on the neutral line changes with output of the neutral voltage regulator, to effectively compensate or offset a voltage of the court; and
in a case that the voltage, acquired by the controller, of the photovoltaic court exceeds a maximum threshold or is less than a minimum threshold, the neutral voltage regulator is controlled to apply a voltage, opposite or identical to the photovoltaic power supply, to the neutral line, so as to offset or compensate the voltage of the court.

As a preferred solution of the method for controlling the overvoltage in the photovoltaic court based on the floating neutral voltage of the present invention, the step of controlling the neutral voltage regulator by the controller to solve the overvoltage problem of the photovoltaic court includes:
acquiring, by the controller, the voltage U of the photovoltaic court, and comparing the voltage with the set maximum threshold Uₘₐₓ and the set minimum threshold Uₘᵢₙ;
returning to the step of acquiring the voltage U of the photovoltaic court in response to the voltage of the photovoltaic court being, Uₘᵢₙ≤U≤Uₘₐₓ, and performing next judgment in response to the voltage U not being within a threshold range; and
controlling the neutral voltage regulator to apply the voltage, with a magnitude being

$$Δ {U}_{1} = U - \frac{{U}_{max} + {U}_{min}}{2} ,$$

opposite to a direction of the photovoltaic power supply to the neutral line in a case of the overvoltage of the photovoltaic court being U>Uₘₐₓ, and controlling the neutral voltage regulator to apply the voltage, with a magnitude being

$$Δ {U}_{1} = \frac{{U}_{max} + {U}_{min}}{2} - U ,$$

identical to the direction of the photovoltaic power supply to the neutral line in a case of a low voltage the photovoltaic court being U<Uₘᵢₙ.

As a preferred solution of the method for controlling the overvoltage in the photovoltaic court based on the floating neutral voltage of the present invention, in a case that the neutral voltage regulator starts to apply the voltage, the controller adopts voltage control at the same time to offset or compensate a voltage fluctuation on the floating neutral line.

As a preferred solution of the method for controlling the overvoltage in the photovoltaic court based on the floating neutral voltage of the present invention, the problems of too high voltage of the transformer neutral point and neutral line electrification in a case of a ground fault of a certain phase of the low voltage to the ground on a photovoltaic court side are solved through the neutral voltage regulator.

As a preferred solution of the method for controlling the overvoltage in the photovoltaic court based on the floating neutral voltage of the present invention, the solving the problems of too high voltage of the transformer neutral point and neutral line electrification includes: immediately sending, by the controller, an instruction to the neutral voltage regulator if the controller detects a rise in the voltage U₀ of the transformer neutral point on a court side, and adjusting a direction and a magnitude of the output voltage;
enabling the neutral point to carry a positive voltage for offsetting if U₀>0, and enabling the neutral point to carry a negative voltage for compensation if U₀>0; and
controlling the voltage of the neutral point always to be 0, so as to prevent a potential of the neutral point from rising and avoid neutral line electrification.

A system for controlling an overvoltage in a photovoltaic court based on a floating neutral voltage using the method of the present invention is provided, including:
a data acquisition unit, used for acquiring, by a controller, a voltage U of the photovoltaic court and a voltage U₀ of a transformer neutral point; and
a control unit, used for comparing acquired voltage data with a set threshold, generating control instructions of offsetting and compensation according to a comparison result, receiving the instructions by a neutral voltage regulator, and controlling a voltage.

A computer device is provided, including a memory in which a computer program is stored and a processor, where when the computer program is executed by the processor, the steps of the method according to any one in the present invention are implemented.

A computer-readable storage medium in which a computer program is stored, where when the computer program is executed by a processor, the steps of the method according to any one in the present invention are implemented.

The present invention has the beneficial effects that the method for controlling the overvoltage in the photovoltaic court based on the floating neutral voltage introduces a floating neutral line between the photovoltaic power supply and the grid-connected transformer neutral point, and arranges the neutral voltage regulator on the floating neutral line. By adjusting its direction and size, the neutral voltage regulator can adapt to the voltage problem of the court in different states. Meanwhile, by adjusting the voltage on the grid-connected transformer neutral point side, the voltage of the grid-connected transformer neutral point is zero.

### BRIEF DESCRIPTION OF DRAWINGS

To more clearly describe the technical solutions of the embodiments of the present invention, the accompanying drawings required to describe the embodiments are briefly described below. Apparently, the accompanying drawings described below are only some embodiments of the present invention. Those skilled in the art may further obtain other drawings based on these accompanying drawings without inventive effort. In the drawings:

FIG. 1 is an overall flow chart of a method for controlling an overvoltage in a photovoltaic court based on a floating neutral voltage provided by a first embodiment of the present invention;

FIG. 2 is a schematic structural diagram of a photovoltaic court of a floating neutral voltage in the method for controlling the overvoltage in the photovoltaic court based on the floating neutral voltage provided by the first embodiment of the present invention;

FIG. 3 is a schematic diagram of a circuit of the photovoltaic court circuit of a floating neutral voltage in the method for controlling the overvoltage in the photovoltaic court based on the floating neutral voltage provided by the first embodiment of the present invention;

FIG. 4 is a diagram of a regulator voltage vector of a floating neutral line in a method for controlling an overvoltage in a photovoltaic court based on a floating neutral voltage provided by a second embodiment of the present invention;

FIG. 5 is a flow chart of actions of a neutral voltage regulator in the method for controlling the overvoltage in the photovoltaic court based on the floating neutral voltage provided by the second embodiment of the present invention;

FIG. 6 is a schematic diagram of outgoing line side grounding of a certain-phase line in a court in a method for controlling an overvoltage in a photovoltaic court based on a floating neutral voltage provided by a third embodiment of the present invention; and

FIG. 7 is a flow chart of voltage control of a transformer neutral point in the method for controlling the overvoltage in the photovoltaic court based on the floating neutral voltage provided by a third embodiment of the present invention.

### DETAILED DESCRIPTION OF THE EMBODIMENTS

In order to make the aforementioned purposes, features and advantages of the present invention more apparent and comprehensible, detailed descriptions of specific embodiments of the present invention are provided below in conjunction with the appended drawings. It is understood that the described embodiments are merely a part of the embodiments of the present invention, rather than all embodiments. Based on the embodiments of the present invention, all other embodiments obtained by those of ordinary skill in the art without creative efforts shall fall within the protection scope of the present invention.

### Embodiment 1

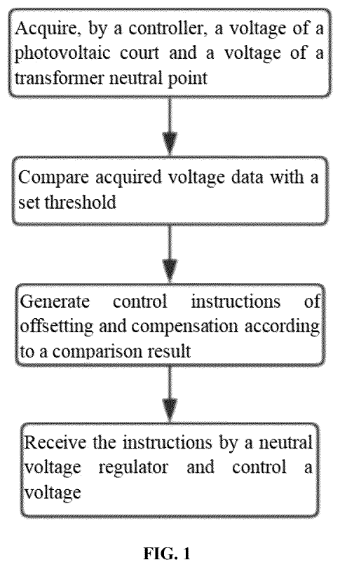

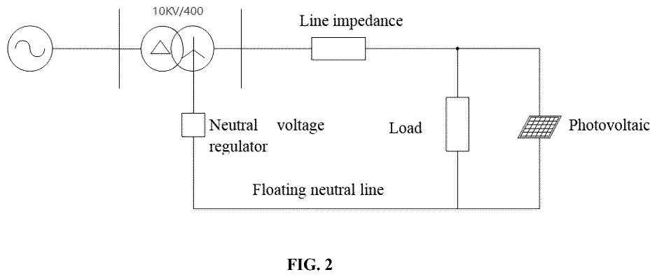

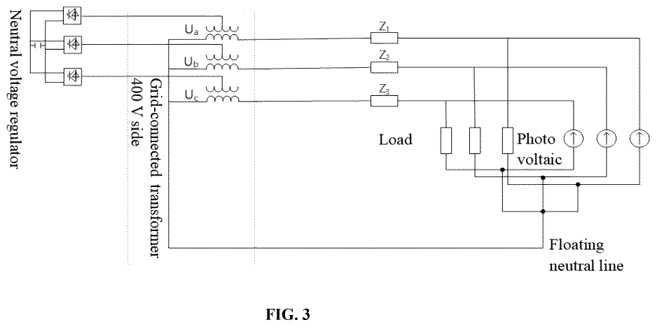

Referring to FIGS. 1-3, showing an embodiment of the present invention, an apparatus for controlling an overvoltage in a photovoltaic court based on a floating neutral voltage is provided, including:
specifically, as shown in FIG. 2 and FIG. 3, a schematic structural diagram of a photovoltaic court of a floating neutral voltage and a schematic diagram of a circuit. Overvoltage control in the photovoltaic court based on the floating neutral voltage includes the following three additional apparatuses:
a floating neutral line, having one end connected to a photovoltaic power supply and the other end connected to a grid-connected transformer neutral point;
the neutral voltage regulator, connected to the grid-connected transformer neutral point of the floating neutral line; and
a controller, connected to the neutral voltage regulator and capable of acquiring a voltage of the photovoltaic court and a voltage of the transformer neutral point, calculating a direction and a magnitude of an output voltage of the neutral voltage regulator, and sending them to the neutral voltage regulator.

Further, through the characteristics of the floating neutral voltage, the overvoltage (low voltage) problem of the photovoltaic court is actively controlled. The characteristic of the floating neutral voltage is that the floating neutral line forms a closed loop between the transformer neutral points on both sides of the neutral line and the photovoltaic power supply, so that the voltage on the neutral line changes with output of the neutral voltage regulator, to effectively compensate or offset a voltage of the court. In a case that the voltage, acquired by the controller, of the photovoltaic court exceeds a maximum threshold or is less than a minimum threshold, the neutral voltage regulator is controlled to apply a voltage, opposite or identical to the photovoltaic power supply, to the neutral line, so as to offset or compensate the voltage of the court.

### Embodiment 2

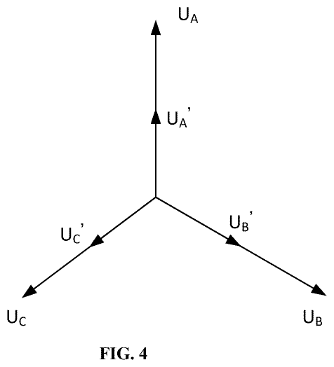

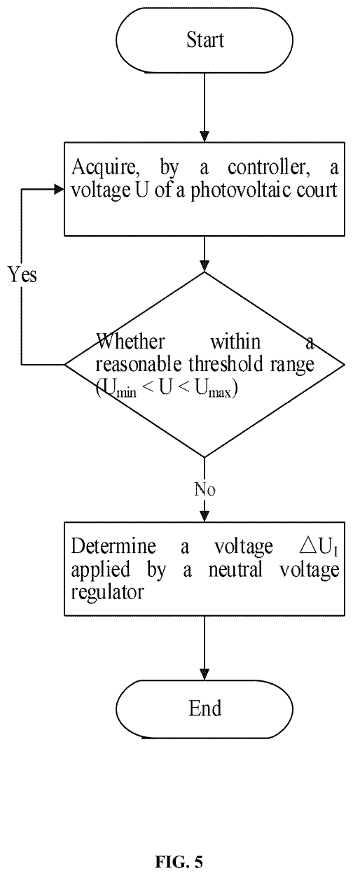

Referring to FIGS. 4-5, showing an embodiment of the present invention, a method for controlling an overvoltage in a photovoltaic court based on a floating neutral voltage is provided, including:
controlling a neutral voltage regulator by a controller to solve an overvoltage problem of the photovoltaic court:
S1: acquiring, by the controller, the voltage U of the photovoltaic court, and comparing the voltage with a set maximum threshold Uₘₐₓ and a set minimum threshold Uₘᵢₙ;
S2: returning to S1 in response to the voltage U of the photovoltaic court being within a threshold range (Uₘᵢₙ≤U≤Uₘₐₓ), and performing the next step S3 in response to the voltage U not being within the threshold range; and
S3: controlling the neutral voltage regulator to apply the voltage, with a magnitude being

$$Δ {U}_{1} = U - \frac{{U}_{max} + {U}_{min}}{2} ,$$

opposite to the direction of the photovoltaic power supply, to the neutral line in a case of overvoltage of the photovoltaic court being max U>Uₘₐₓ, and controlling the neutral voltage regulator to apply the voltage, with a magnitude being

$$Δ {U}_{1} = \frac{{U}_{max} + {U}_{min}}{2} - U ,$$

identical to the direction of the photovoltaic power supply, to the neutral line in a case of a low voltage of the photovoltaic court being U<Uₘᵢₙ.

Further, in the diagram of a regulator voltage vector of a floating neutral line, U_{A}′, U_{B}′, are U_{C}′ regulator voltages of the floating neutral line; and in a case of fluctuations of three-phase voltages U_{A}, U_{B}, and U_{C} in the photovoltaic court, magnitudes and directions of U_{A}′, U_{B}′, and U_{C}′ are controlled by the neutral voltage regulator to achieve the effects of suppressing the overvoltage of the photovoltaic court and compensating an undervoltage of the photovoltaic court, as shown in FIG. 4. The step of controlling the neutral voltage regulator by a controller to solve an overvoltage (low voltage) problem of the court is shown in FIG. 5.

### Embodiment 3

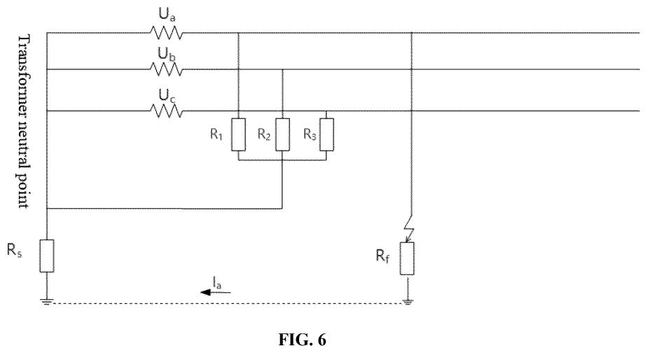

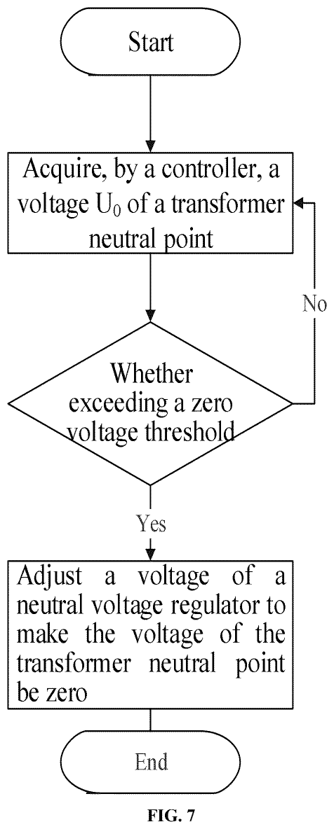

Referring to FIGS. 6-7, showing an embodiment of the present invention, a method for controlling an overvoltage in a photovoltaic court based on a floating neutral voltage is provided, including:
specifically, as shown in FIG. 7, a flow chart of voltage control of a transformer neutral point. The controlling the neutral voltage regulator by the controller to solve the neutral line electrification problem includes the following steps:
S1: acquiring, by the controller, the voltage U₀ of the transformer neutral point, and comparing the voltage with a set neutral voltage threshold;
S2: returning to S1 in response to the controller judging the voltage of the transformer neutral point to be zero or within a threshold range; and performing S3 in response to the voltage of the transformer neutral point not being zero or being within the threshold range; and
S3: calculating, by the controller, the magnitude of the voltage required to offset or compensate the voltage of the neutral voltage regulator to zero, and adjusting its output voltage to ensure that the voltage of the transformer neutral point is zero.

Further, the controller immediately sends an instruction to the neutral voltage regulator if it detects a rise in the voltage U₀ of the transformer neutral point on the court side, and adjusts a direction and a magnitude of the output voltage; the neutral point carries a positive voltage for offsetting if U₀>0, and the neutral point carries a negative voltage for compensation if U₀>0; and the voltage of the neutral point is controlled always to be 0, so as to prevent a potential of the neutral point from rising and avoid neutral line electrification.

It is to say, in the controller controlling the neutral voltage regulator to solve the neutral line electrification problem, the method for voltage offsetting and compensation have similar steps to the method in solving the overvoltage problem of the photovoltaic court.

The neutral voltage regulator is controlled to apply the voltage, with a magnitude being ΔU₀₁=|U₀|, opposite to the direction of the transformer neutral point to the neutral line to offset in a case that the voltage U₀ of the transformer neutral point is positive. The neutral voltage regulator is controlled to apply the voltage, with a magnitude being ΔU₀₁=|U₀|, identical to the direction of the transformer neutral point to the neutral line in a case that the low voltage U₀ of the photovoltaic court is negative. Here, because the voltage is negative, a value of |ΔU₀₁| is positive, and it can be ensured that the neutral point is not charged by inputting the voltage in the same direction.

It should also be known that the controller controls the neutral voltage regulator to solve the problems of too high voltage of the transformer neutral point and neutral line electrification in a case of the ground fault of the certain phase of the low voltage to the ground on the photovoltaic court side through the neutral voltage regulator, to avoid affecting the power grid. As shown in FIG. 6, it shows a schematic diagram of outgoing line side grounding of a certain-phase line in the court. If there is a ground fault in phase a on the court side, a fault current Iₐ forms a loop through a phase line, the ground, and a grounding resistance. Because the grounding resistance R_{f} and an equivalent resistance Rₛ of the ground are not zero, the fault current Iₐ leads to voltage drops on the grounding resistance R_{f} and the equivalent resistance Rₛ of the ground, which causes the potential of the neutral point to the ground to rise, thereby leading to neutral line electrification. The voltage on the neutral line is:

$${U}_{0} = {I}_{a} \cdot {R}_{s}$$

In the formula, U₀ is the voltage of the neutral line to the ground.

As the floating neutral line is connected to the transformer neutral point, the problem of neutral line electrification can be solved by using the neutral voltage regulator in the floating neutral line. It is characterized in that once the controller detects a voltage rise of the transformer neutral point on the court side, it immediately sends the instruction to the neutral voltage regulator to adjust the direction and the magnitude of its output voltage. Offsetting or compensating the voltage rise, caused by the fault, of the transformer neutral point prevents the potential of the neutral point from rising and avoids neutral line electrification.

In another aspect, the embodiment further provides a system for controlling an overvoltage in a photovoltaic court based on a floating neutral voltage is provided, including:
a data acquisition unit, used for acquiring, by a controller, a voltage U of the photovoltaic court and a voltage U₀ of a transformer neutral point; and a control unit, used for comparing acquired voltage data with a set threshold, generating control instructions of offsetting and compensation according to a comparison result, receiving the instructions by a neutral voltage regulator, and controlling a voltage.

If the above functions are implemented in a form of a software functional unit, and sold or used as an independent product, the functions may be stored in a computer-readable storage medium. Based on this understanding, the technical solution of the present invention essentially or a part that contributes to the prior art; or part of the technical solution may be embodied in a form of a software product; and the computer software product is stored in a storage medium and includes a plurality of instructions which are used to enable a computer device (which may be a personal computer, a server, or a network device, etc.) to execute all or part of the steps of the methods described in the various embodiments of the present invention. The storage medium includes: a USB flash disk, a mobile hard disk, a read-only memory (ROM), a random access memory (RAM), a magnetic disk or an optical disk and another medium that can store program codes.

Logics and/or steps expressed in the flow chart or otherwise described herein, for example, may be considered as a sequence table of executable instructions for implementing logical functions, and may be implemented in any computer-readable medium for use by instruction execution systems, apparatuses, or devices (such as computer-based systems, systems including processors, or other systems that may acquire instructions from the instruction execution systems, the apparatuses, or the devices and execute the instructions), or in a combination manner. For the purposes of this specification, the “computer-readable medium” may be any device that may contain, store, communicate, propagate or transmit a program for use by the instruction execution systems, the apparatuses, or the devices or in a combination manner.

More specific examples of the machine-readable storage medium (non-exhaustive list) may include an electrical connection (an electronic apparatus) with one or more wires, a portable computer disk case (a magnetic apparatus), a random access memory (RAM), a read-only memory (ROM), an erasable programmable read-only memory (EPROM or flash memory), an optical fiber, and a portable compact disk read-only memory (CDROM). In addition, the computer-readable medium may even be paper or other appropriate media on which the program may be printed. It because that the program may be acquired electronically, for example, by optically scanning the paper or other media, followed by editing, interpretation or, if necessary, other appropriate processing ways, and then stored in a computer memory.

It should be understood that each part of the present invention can be achieved by hardware, software, firmware or a combination thereof. In the above implementation, multiple steps or methods can be implemented with the software or the firmware stored in the memory and executed by the appropriate instruction execution system. For example, if they are implemented by the hardware, as in another implementation, they may be implemented by any one of the following technologies well known in the art or their combination: a discrete logic circuit with a logic gate circuit for implementing a logic function of a data signal, a special integrated circuit with an appropriate combinational logic gate circuit, a programmable gate array (PGA), a field programmable gate array (FPGA), etc.

### Embodiment 4

The following is an embodiment of present invention, which provides a method for controlling an overvoltage in a photovoltaic court based on a floating neutral voltage. In order to verify the beneficial effects of the present invention, scientific demonstration is performed through economic benefit calculation and a simulation experiment.

By comparing 100 experiments each before and after the present invention, several parameters are obtained as shown in Table 1.

TABLE 1
Data Comparison Table

| | condition | | | |
|---|---|---|---|---|
| | Before use | | After use | |
| | of present | | of present | |
| Parameter | invention | | invention | |
| Average number of overvoltage | 10 | times | 2 | times |
| occurrences/d | | | | |
| Maximum voltage peak/V | 260 | V | 240 | V |
| Voltage fluctuation of transformer | ±5% | | ±1% | |
| neutral point (%) | | | | |
| Power grid fault response time (ms) | 500 | ms | 100 | ms |

| | | |
|---|---|---|
| Device damage rate/year | 5% | 1% |
| Annual energy efficiency improvement (%) | 0% | 3% |

The present invention reduces the number of overvoltage occurrences per day from 10 times to 2 times. This indicates that the efficiency of the system in overvoltage management is greatly improved, which is of great significance to stable operation of a device and the power grid. After use of the present invention, a maximum voltage peak in the system is reduced from 260 V to 240 V. This reduction is conducive to preventing electrical device overload and damage, prolonging the service life of the device, and reducing a maintenance cost. The present invention reduces the voltage fluctuation of the transformer neutral point from ±5% to ±1%, which significantly improves voltage stability. This is very important for maintaining overall stability and safe operation of the power grid. The present invention can respond to the power grid fault within 100 ms, and the response time is greatly shortened compared with 500 ms without using the present invention. This rapid response capability is critical to prevent or weaken the influence on the power grid fault. Through more effective voltage management, the present invention reduces an annual damage rate of the device from 5% to 1%, which means less maintenance and replacement costs, thereby increasing the economic benefit. By improving voltage management, the energy efficiency of the system is improved by 3%, energy waste is reduced, and the overall energy efficiency is improved. In summary, through an innovative voltage management method, the present invention improves the energy efficiency of the system, reduces an operating cost, and enhances the response capability to the power grid fault while ensuring the voltage stability of the photovoltaic court. These advantages make the present invention have an important application value in the fields of power systems and photovoltaic power generation.

It should be noted that the above embodiments are only used to illustrate the technical solution of the present invention and are not for limitation. Although the present invention is described in detail with reference to the preferred embodiments, those of ordinary skill in the art should understand that the technical solutions of the present invention may be modified or replaced by equivalents without departing from the spirit and scope of the technical solutions of the present invention, and all those modifications or replacements should be included in the scope of the claims of the present invention.

What is claimed is:

1. A method for controlling an overvoltage in a photovoltaic court based on a floating neutral voltage, comprising:
Acquiring, by a controller, a voltage U of the photovoltaic court and a voltage U₀ of a transformer neutral point;
comparing acquired voltage data with a set threshold;
generating control instructions of offsetting and compensation according to a comparison result; and
receiving the instructions by a neutral voltage regulator, and controlling a voltage.

2. The method for controlling the overvoltage in the photovoltaic court based on the floating neutral voltage according to claim 1, wherein an overvoltage control apparatus comprises: a floating neutral line, having one end connected to a photovoltaic power supply and the other end connected to a grid-connected transformer neutral point;
the neutral voltage regulator, connected to the grid-connected transformer neutral point of the floating neutral line; and
a controller, connected to the neutral voltage regulator and capable of acquiring a voltage of the photovoltaic court and a voltage of the transformer neutral point, calculating a direction and a magnitude of an output voltage of the neutral voltage regulator, and sending the direction and the magnitude to the neutral voltage regulator.

3. The method for controlling the overvoltage in the photovoltaic court based on the floating neutral voltage according to claim 2, wherein the overvoltage control apparatus further comprises: the floating neutral line can form a closed loop between the transformer neutral points on both sides of the neutral line and the photovoltaic power supply, so that the voltage on the neutral line changes with output of the neutral voltage regulator, to effectively compensate or offset a voltage of the court; and
in a case that the voltage, acquired by the controller, of the photovoltaic court exceeds a maximum threshold or is less than a minimum threshold, the neutral voltage regulator is controlled to apply a voltage, opposite or identical to the photovoltaic power supply, to the neutral line, so as to offset or compensate the voltage of the court.

4. The method for controlling the overvoltage in the photovoltaic court based on the floating neutral voltage according to claim 3, wherein the step of controlling the neutral voltage regulator by the controller to solve the overvoltage problem of the photovoltaic court comprises:
acquiring, by the controller, the voltage U of the photovoltaic court, and comparing the voltage with the set maximum threshold Uₘₐₓ and the set minimum threshold Uₘᵢₙ;
returning to the step of acquiring the voltage U of the photovoltaic court in response to the voltage of the photovoltaic court being Uₘᵢₙ≤U≤Uₘₐₓ, and performing next judgment in response to the voltage U not being within a threshold range; and
controlling the neutral voltage regulator to apply the voltage, with a magnitude being
$$Δ {U}_{1} = U - \frac{{U}_{max} + {U}_{min}}{2} ,$$
opposite to a direction of the photovoltaic power supply to the neutral line in a case of the overvoltage of the photovoltaic court being U>Uₘₐₓ, and controlling the neutral voltage regulator to apply the voltage, with a magnitude being
$$Δ {U}_{1} = \frac{{U}_{max} + {U}_{min}}{2} - U ,$$
identical to the direction of the photovoltaic power supply to the neutral line in a case of a low voltage the photovoltaic court being U<Uₘᵢₙ.

5. The method for controlling the overvoltage in the photovoltaic court based on the floating neutral voltage according to claim 4, wherein in a case that the neutral voltage regulator starts to apply the voltage, the controller adopts voltage control at the same time to offset or compensate a voltage fluctuation on the floating neutral line.

6. The method for controlling the overvoltage in the photovoltaic court based on the floating neutral voltage according to claim 5, wherein the problems of too high voltage of the transformer neutral point and neutral line electrification in a case of a ground fault of a certain phase of the low voltage to the ground on a photovoltaic court side are solved through the neutral voltage regulator.

7. The method for controlling the overvoltage in the photovoltaic court based on the floating neutral voltage according to claim 6, wherein the solving the problems of too high voltage of the transformer neutral point and neutral line electrification comprises: immediately sending, by the controller, an instruction to the neutral voltage regulator if the controller detects a rise in the voltage U₀ of the transformer neutral point on a court side, and adjusting a direction and a magnitude of the output voltage;
enabling the neutral point to carry a positive voltage for offsetting if U₀>0, and enabling the neutral point to carry a negative voltage for compensation if U₀>0; and
controlling the voltage of the neutral point always to be 0, so as to prevent a potential of the neutral point from rising and avoid neutral line electrification.

8. A system for controlling an overvoltage in a photovoltaic court based on a floating neutral voltage using the method according to claim 1, comprising:
a data acquisition unit, used for acquiring, by a controller, a voltage U of the photovoltaic court and a voltage U₀ of a transformer neutral point; and
a control unit, used for comparing acquired voltage data with a set threshold, generating control instructions of offsetting and compensation according to a comparison result, receiving the instructions by a neutral voltage regulator, and controlling a voltage.

9. A computer device, comprising a memory in which a computer program is stored and a processor, wherein when the computer program is executed by the processor, the steps of the method for controlling the overvoltage in the photovoltaic court based on the floating neutral voltage are implemented.

10. A computer-readable storage medium in which a computer program is stored, wherein when the computer program is executed by a processor, the steps of the method for controlling the overvoltage in the photovoltaic court based on the floating neutral voltage are implemented.
